(19) United States
(12) Patent Application Publication
(10) Pub. No.: US 2011/0232522 A1
(43) Pub. Date: Sep. 29, 2011

(54) METHOD AND COMPOSITION FOR THE TREATMENT OF A SUBSTRATE

(76) Inventors: Somnath Das, Bangalore (IN); Amitava Pramanik, Bangalore (IN); Srinivasa Raman, Bangalore (IN); Arpita Sarkar, Bangalore (IN)

(21) Appl. No.: 13/132,999

(22) PCT Filed: Nov. 25, 2009
(86) PCT No.: PCT/EP2009/065859

§ 371 Date: Jun. 6, 2011

(30) Foreign Application Priority Data
Dec. 16, 2008 (IN) 2622/MUM/2008
Sep. 4, 2009 (IN) 2026/MUM/2009

(51) Int. Cl. C09D 5/00

(52) U.S. Cl. 106/2

(57) ABSTRACT

It has been found that hydrophobicity and stain-resistance can be imparted to a substrate by contacting the substrate with soap and a polyaluminum chloride in presence of water under specific range of pH, while the further addition of a quaternary silicone oil imparts oily soil repellence.

### TECHNICAL FIELD

This invention relates to a method and composition for treatment of a substrate. It particularly relates to a method and composition for treatment of a fabric substrate for imparting repellency of aqueous and oily soils.

### BACKGROUND AND PRIOR ART

Any discussion of the prior art throughout the specification should in no way be considered as an admission that such prior art is widely known or forms part of the common general knowledge in the field.

Conventional cleaning methods are directed towards effective cleaning of soils from the fabrics. Some cleaning formulations include soil release agents that make it easier for oily soils to be cleaned from fabrics. However, conventional cleaning formulations do not help much in reducing subsequent post-wash soiling of the fabric.

On the other hand, various industrial treatments for fabric modification are known to render the fabric hydrophobic by lowering surface energy or by providing a surface texture with optimum roughness or by a combination of both the approaches. The fabric modification of this type is normally carried out during textile manufacture and involves elaborate processes using expensive chemicals such as fluoropolymers. Further, these processes are relatively difficult to be conveniently used in household.

Thus there is an unfulfilled need for a fabric treating method that can be used in household for reduction of subsequent soiling of fabrics.

One such method, disclosed in our copending application 1691/MUM/2007 (Hindustan Unilever Limited), is a multi-step method of treating a fabric with a compound of alkaline earth metal, titanium or zinc, with a water-soluble compound of aluminium, and with C8-C24 soap, in presence of an aqueous carrier. However, the multi-step method disclosed therein is relatively less convenient and relatively less user-friendly. Furthermore, for the method to be used effectively, it must be communicated to the end-user to apply the ingredients to the fabric in a stepwise manner. End-users may not have adequate level of education to follow the instructions correctly and there is a need for a single step method for imparting hydrophobicity and reducing subsequent cleaning.

It is an object of the present invention to overcome or ameliorate at least one of the disadvantages of the prior art, or to provide a useful alternative.

One of the objects of the present invention is to provide a method of treating a fabric to provide repellence to both oily and aqueous soils and stains.

One of the objects of the present invention is to provide a method of treating a fabric to render the fabrics relatively more hydrophobic.

Another object of the present invention is to provide a method of treating a fabric to impart relatively better stain-resistance to the fabric.

Yet another object of the present invention is to provide a method of treating fabric that improves subsequent cleaning of fabrics.

Yet another object of the present invention is to provide a single-step method for imparting hydrophobicity and stain-resistance to a fabric.

The present inventors have surprisingly found that hydrophobicity and stain-resistance can be imparted to a substrate by contacting the substrate with soap and a water-soluble compound of trivalent or tetravalent metal in presence of water under specific range of pH, while the further addition of a quaternary silicone oil imparts oily soil repellence.

### SUMMARY OF THE INVENTION

According to one aspect of the present invention there is provided a method of treatment of a substrate comprising the step of contacting the substrate with an aqueous component comprising water and a composition comprising:
(a) a soap, and
(b) a water-soluble compound of trivalent or tetravalent metal,
   wherein pH of the aqueous component is less than 6.

According to another aspect of the present invention there is provided a composition for treatment of a substrate comprising:
(a) from 30 to 90% a soap,
(b) from 30 to 90% a water-soluble compound of trivalent or tetravalent metal, and;
(c) from 0 to 20% of a pH modifying agent;
wherein the pH of 1% by weight of the composition in water is less than 6.

These and other aspects, features and advantages will become apparent to those of ordinary skill in the art from a reading of the following detailed description and the appended claims. For the avoidance of doubt, any feature of one aspect of the present invention may be utilised in any other aspect of the invention. The word “comprising” is intended to mean “including” but not necessarily “consisting of” or “composed of.” In other words, the listed steps or options need not be exhaustive. It is noted that the examples given in the description below are intended to clarify the invention and are not intended to limit the invention to those examples per se. Similarly, all percentages are weight/weight percentages unless otherwise indicated. Except in the operating and comparative examples, or where otherwise explicitly indicated, all numbers in this description indicating amounts of material or conditions of reaction, physical properties of materials and/or use are to be understood as modified by the word “about”. Numerical ranges expressed in the format “from x to y” are understood to include x and y. When for a specific feature multiple preferred ranges are described in the format “from x to y”, it is understood that all ranges combining the different endpoints are also contemplated.

### DETAILED DESCRIPTION OF THE INVENTION

### The Substrate

The method of the present invention can be used to treat metal, glass, ceramic, fabric and paper substrates. Preferably, the substrate is a fabric, paper or glass. More preferably the substrate is a fabric. The fabric that can be treated includes synthetic as well as natural textiles. Fabrics may be made of cotton, polycotton, polyester, silk or nylon. It is envisaged that the method of the present invention can be used to treat garments and other clothing and apparel materials that form typical wash-load in household laundry. The household materials that can be treated according to the process of the present invention include, but are not limited to, bedspreads, blankets, carpets, curtains and upholstery. Although the process of the present invention is described primarily for treatment of a fabric, it is envisaged that the process of the present invention can be advantageously used to treat other materials such as jute, denim and canvass. It is envisaged that the process of the present invention can be used to treat articles such as shoes and jackets.

### The Soap

The substrate is contacted with a composition comprising soap. The soap is preferably C8-C24 soap, more preferably C10-C20 soap and most preferably C12-C16 soap.

The soap may or may not have one or more carbon-carbon double bond or triple bond. The iodine value of the soap, which is indicative of degree of unsaturation, is preferably less than 20, more preferably less than 10, and most preferably less than 5. Saturated soap having no carbon-carbon double bond or triple bond is particularly preferred.

The soap may be water-soluble or water insoluble. Non-limiting examples of water-soluble soaps that can be used according to the present invention include sodium laurate, sodium caprylate, and sodium myristate.

The soap is preferably from 0.0005 to 0.5%, more preferably between 0.001 to 0.5% most preferably between 0.001 to 0.2% by weight of the aqueous component.

The amount of the soap is preferably from 0.0001 to 25, more preferably from 0.001 to 10 mg per cm² of the substrate area.

### The Water-Soluble Compound of Trivalent or Tetravalent Metal

The substrate is contacted with a composition comprising a water-soluble compound of trivalent or tetravalent metal. The term water-soluble compound as used herein means a compound that has solubility of at least 0.05 g per 100 g water at 25° C.

The solubility of the water-soluble compound of trivalent or tetravalent metal is preferably greater than 0.1, more preferably greater than 1 and most preferably greater than 5 g per 100 g of water at a temperature of 25° C.

Water soluble compound may be of trivalent metal or a tetravalent metal. Preferably, the water soluble compound is of trivalent metal. Preferably the trivalent metal cation is chosen from aluminium, iron, Bismuth or titanium. More preferably the trivalent metal is chosen from aluminium or iron. Most preferably, the trivalent metal is aluminium.

Water soluble compound may be of any tetravalent metal cation. Preferably the tetravalent metal cation is titanium, Zirconium or Tin.

Although water-soluble compounds of both trivalent and tetravalent metal can be used, trivalent metal compounds are preferred.

The water-soluble compound is preferably from 0.0005 to 0.5%, more preferably between 0.001 to 0.5% most preferably between 0.001 to 0.2% by weight of the aqueous component. The weight % of water-soluble compound is on anhydrous basis.

The amount of the water-soluble compound of trivalent or tetravalent metal is preferably 0.0001 to 25, more preferably from 0.001 to 10 mg per cm² of the substrate area.

The weight ratio of the soluble compound of trivalent or tetravalent metal to the soap is preferably from 1:10 to 10:1, more preferably from 1:5 to 5:1, and most preferably from 1:2 to 2:1.

The compound of trivalent or tetravalent metal can be acidic or alkaline. Preferred acidic compound are mineral acid salt of trivalent or tetravalent metal. Some examples of acidic compounds are nitrate, chloride, and sulphate. Alkaline compounds can be used provided that the pH is reduced by use of pH modifier. Preferred alkaline compound of aluminium includes aluminate of alkali metal. Sodium aluminate is a particularly preferred. It is preferable that the molar ratio of Na2O to Al2O3 in sodium aluminate is from 1.5:1 to 1:1, more preferably from 1.3:1 to 1:1 and most preferably from 1.25:1 to 1.1:1.

Some particularly preferred water-soluble aluminium compounds include polyaluminiunm chloride and polyaluminium sulphate. Water-insoluble aluminium compounds like clays, alumina and aluminium hydroxide are excluded from the scope of the present invention.

It is preferred that the log concentration of total soluble trivalent or tetravalent cationic species is greater than −6. It is particularly preferred that when the trivalent metal is aluminium or iron, the log concentration of total soluble trivalent or tetravalent cationic species is greater than −6. The log concentration of total soluble trivalent/tetravalent cationic species depends upon concentration of the soluble salt and pH and can be determined by a person skilled in the art from solubility diagrams. (For example, see Gregory and Duan, Pure Appl. Chem., Vol. 73, No. 12, pp. 2017-2026, 2001 for solubility diagrams for aluminium and iron).

### Oily Soil Repellence

To further provide the repellence of oily soils and stains, the composition may further comprise a quaternary silicone oil, e.g. PDMS (poly dimethyl siloxane). This quaternary silicone oil may be present in the compositions in a concentration of less than 40% by weight. The composition preferably comprises less than 35% by weight more preferably even less than 30% by weight, but preferably more than 0.5% by weight, more preferably more than 10% by weight.

The quaternary silicone, when used, is typically present in the wash liquor in a concentration of less than 5 g/l, more preferably less than 2 g/l, or even less than 1 g/l. The composition is typically present in a concentration of more than 0.01 g/l, more preferably more than 0.05 g/l, or even more than 0.1 g/l.

The quaternary silicone oil may be present in the composition as is, or in immobilised form (e.g. in the form of a granule or a capsule). The quaternary silicone oil may also be added to the wash liquor separately.

### The pH Modifying Agent

It is essential that the pH of the aqueous component is maintained at a value less than 6. The pH of the aqueous component is preferably greater than 1.

The pH of the aqueous components is preferably below the iso-electric point.

When the trivalent metal is aluminium, titanium, iron or bismuth, the pH of the aqueous component is preferably between 2 and 6.

When the trivalent metal is iron, the pH of the aqueous component is more preferably between 1 and 3.5

When the trivalent metal is titanium, the pH of the aqueous component is more preferably between 1 and 3.

When the tetravalent metal is titanium, zirconium or tin, the pH of the aqueous component is preferably between 1 and 3, more preferably between 1 and 2.

It is known to a person skilled in the art to select a pH modifying agent depending on the desired pH of the aqueous component and pH of the composition in absence of the pH modifying agent. Accordingly, pH modifying agent may be acidic or alkaline. Acidic pH modifying agents include both inorganic as well as organic acids. Alkaline pH modifying agents include both inorganic as well as organic bases. Preferred alkaline pH modifying agents are selected from carbonates, bicarbonates, polyphosphates and hydroxides of alkali metal.

When the substrate is fabric, the ratio of water to the fabric is preferably greater than 3, more preferably greater than 5 and most preferably greater than 10.

### Other Ingredients in the Composition

The composition may comprise commonly used ingredients such as fluorescer, preservative, perfume, and shading dyes.

### The Composition for Treatment of a Substrate

The solid composition for treatment of a substrate comprising:
(a) from 10 to 90% a soap,
(b) from 10 to 90% a water-soluble compound of trivalent or tetravalent metal, and;
(c) from 0 to 20% of a pH modifying agent.
(d) From 0 to 40% of a quaternary silicone oil.
   wherein pH of 1% by weight of the composition in water is less than 6.

It is known to a person skilled in the art to select a pH modifying agent and its amount in the composition in order to maintain pH of 1% by weight of the composition in water at a value less than 6. pH modifying agent is not essential in case the pH of 1% by weight of the composition comprising (a) and (b) without the pH modifying agent is less than 6.

### EXAMPLES

The invention will now be demonstrated with examples. The examples are for the purpose of illustration only and do not limit the scope of the invention in any manner.

### Treatment of a Fabric Substrate

Aqueous components were prepared by adding compositions comprising soap and a water-soluble compound of metal (divalent trivalent or tetravalent) to water. pH modifying agent was added dropwise to attain specific pH values. Log concentration of soluble cationic species was determined from pH and the concentration of water-soluble compounds using the solubility diagrams. Fabric swatches (10 cm by 10 cm) of desized cotton/polycotton/polyester (Bombay Dyeing, India) were used and the experimental results are reported on the basis of 5 fabric swatches unless specified otherwise. Fabric swatches were immersed in the mixtures at water to fabric ratio of about 10.

### Evaluation of Fabric Hydrophobicity (HP)

A droplet of water is dropped on a fabric kept horizontally from a height of ˜2 cm and the behaviour of the droplet is studied and the ratings are given as tabulated below.

TABLE 1
Hydrophobicity ratings

| Time taken by droplet to wick in fabric | Hydrophobicity rating |
|---|---|
| Fabric not wetted till 10 seconds after contacting. | Superhydrophobic (S) |
| Fabric not wetted till 5 seconds after contacting. | Hydrophobic (H) |
| Fabric is wetted between 5 and 10 seconds | |
| Fabric wetted in less than 5 seconds after | Wicking (W) |
| contacting | |

### Evaluation of Stain Repellency (SR) of Fabrics

A 10×10 cm² fabric is held at ˜70° angle to the horizontal. A drop of a tea stain is dropped on the fabric from a height of ˜2 cm. If the stain either beads up or rolls out of the fabric, it is considered to be stain repellent. If the stain wicks on the fabrics, it is considered not stain repellent.

### Experimental Results

Results of the evaluation of hydrophobicity and stain resistance for various compositions along with the composition details are tabulated in Tables 2-5 below:

TABLE 2
Iron compounds (trivalent)

| Ex No | PMA | Soap (g/L) | pH | Log (M³⁺) | HP | SR |
|---|---|---|---|---|---|---|
| 1 | HCl | Laurate (0.6) | 2 | −2.7 | S | Y |
| 2 | NaOH | Laurate (0.6) | 3 | −4.7 | S | Y |
| A | HCl | Laurate (0.6) | 1 | −2.7 | S | Y |
| B | NaOH | Laurate (0.6) | 7 | −8.3 | W | N |
| C | NaOH | No soap | 3 | −4.7 | W | N |
| D | HCl | Laurate (0.6) | 3 | −4.7 | W | N |

All the examples below, except example D, soluble metal salt was ferric chloride hexahydrate (0.54 g/L). Example D did not have ferric chloride hexahydrate
PMA—pH modifying agent
HP—Hydrophobicity rating
SR—Stain repellency rating

In all the examples below, the treatment solution has 0.41 g/L sodium myristate soap.

TABLE 3
Calcium and magnesium compounds (divalent)

| Ex No | Salt of metal (g/L) | | PMA | pH | Log (M²⁺) | HP | SR |
|---|---|---|---|---|---|---|---|
| E | CaCl₂ | (0.088) | HCl | 3 | −3.22 | W | N |
| F | CaCl₂ | (5.0) | HCl | 3 | −1.47 | W | N |
| G | MgCl₂ | (0.122) | HCl | 3 | −3.22 | W | N |
| H | MgCl₂ | (6.9) | HCl | 3 | −1.47 | W | N |

In all the examples below, the treatment solution has 0.48 g/L aluminium chloride hexahydrate.

TABLE 4
Aluminium compounds (Trivalent)

| Ex No | PMA | Soap (g/L) | | pH | Log (M³⁺) | HP | SR |
|---|---|---|---|---|---|---|---|
| 3 | HCl | Laurate | (0.6) | 2 | −2.7 | H | Y |
| 4 | HCl | Laurate | (0.6) | 3 | −2.7 | H | Y |
| 5 | NaOH | Laurate | (0.6) | 4 | −2.7 | S | Y |
| 6 | NaOH | Laurate | (0.6) | 5 | −4.1 | S | Y |
| 7 | NaOH | Laurate | (0.6) | 6 | −5.6 | S | Y |
| 8 | NaOH | Myristate | (0.6) | 4 | −2.7 | S | Y |
| 9 | NaOH | Myristate | (0.6) | 4 | −2.7 | S | Y |
| I | HCl | Laurate | (0.6) | 1 | −2.7 | W | N |
| J | NaOH | Laurate | (0.6) | 7 | −5.3 | W | N |

| | | | | | | |
|---|---|---|---|---|---|---|
| K | NaOH | No soap | 3 | −2.7 | W | N |

TABLE 5
Titanium compounds (Trivalent and tetravalent)

| Ex No | Salt of metal (g/L) | PMA | Soap (g/L) | pH | HP | SR |
|---|---|---|---|---|---|---|
| 10 | TiCl₃ (0.49) | HCl | Myristate (0.41) | 1 | S | Y |
| 11 | TiCl₃ (0.49) | HCl | Myristate (0.41) | 2 | S | Y |
| 12 | TiCl₃ (0.49) | HCl | Myristate (0.41) | 3 | S | Y |
| 13 | TiCl₄ (0.49) | HCl | Myristate (0.41) | 1 | S | Y |
| 14 | TiCl₄ (0.49) | HCl | Myristate (0.41) | 2 | S | Y |

From the results, it is clear that fabrics treated with water-soluble compounds of trivalent and tetravalent metals are rendered hydrophobicity and stain resistance unlike the fabrics treated with water-soluble compounds of divalent metals under otherwise identical conditions. The results indicate that presence of both the soap and the water-soluble compound of trivalent or tetravalent metal is essential for rendering the fabric hydrophobic. The results also demonstrate the optimal range of pH for aluminum, titanium and iron compounds.

### Fabric Treatment—Example 15

To 1 L of deionised water 0.266 g of anhydrous aluminium chloride, 0.0255 g of aluminium chloride hexahydrate, 0.18 g of anhydrous zinc chloride and 0.41 g of potassium myristate were added and dissolved to get the aqueous component which had pH of 4.5.

100 fabrics each of 1 g (100 cm²) were soaked in 1 L of the above aqueous component for 20 minutes. After soaking the fabrics were rinsed once in 1 L of deionised water and dried in air and ironed.

### Fabric Treatment—Example 16

To 1 L of deionised water 0.266 g of anhydrous aluminium chloride, 0.0255 g of aluminium chloride hexahydrate and 0.41 g of potassium myristate were added and dissolved to get the aqueous component which had pH of 4.5.

100 fabrics each of 1 g (100 cm²) were soaked in 1 L of the above aqueous component for 20 minutes. After soaking the fabrics were rinsed once in 1 L of deionised water and dried in air and ironed.

### Fabric Treatment—Example 17

To 1 L of deionised water 0.51 g of poly aluminium chloride and 0.41 g of potassium myristate were added and dissolved to get the aqueous component which had pH of 4.5.

100 fabrics each of 1 g (100 cm²) were soaked in 1 L of the above aqueous component for 20 minutes. After soaking the fabrics were rinsed once in 1 L of deionised water and dried in air and ironed.

### Fabric Treatment—Comparative Example L

100 fabrics each of 1 g (100 cm²) were soaked in 1 L of the deionised water for 20 minutes. After soaking the fabrics were rinsed once in 1 L of deionised water and dried in air and ironed.

### Fabric Treatment—Example 18

To 1 L of deionised water 0.18 g of zinc chloride, 0.51 g of aluminium chloride hexahydrate, 0.08 g sodium carbonate and 0.41 g of sodium oleate were added and dissolved to get the aqueous component which had pH of 4.5.

100 fabrics each of 1 g (100 cm²) were soaked in 1 L of the above aqueous component for 20 minutes. After soaking the fabrics were rinsed once in 1 L of deionised water and dried in air and ironed.

### Fabric Treatment—Example 19

To 1 L of deionised water 0.4 g of sodium aluminate, 0.48 g sodium laurate were added. Hydrochloric acid was added to adjust pH at 4.5.

100 fabrics each of 1 g (100 cm²) were soaked in 1 L of the above aqueous component for 20 minutes. After soaking the fabrics were rinsed once in 1 L of deionised water and dried in air and ironed.

### Soiling Protocol

### Carbon Soot Soiling:

In 1 L of deionised water 150 mg of Carbon Soot (Cabot India) was taken. This dispersion was sonicated for 2 hours in a bath sonicator.

To 80 ml of the above dispersion, 10 fabrics (1 g each) were dipped and taken out immediately. The soiled fabrics were line dried in air overnight.

### Red Mud Soiling:

To 1 L of deionised water 5 g of red mud (ex HURC, sieved, particle size <150 microns) was added and sonicated in a bath sonicator for 2 hours.

In 100 ml of the above slurry, 10 fabrics (of 1 g each) were dipped and taken out immediately. The soiled fabrics were line dried in air overnight.

### Tea Stain Soiling

2 tea bags of tea were dipped in 150 ml of hot milk to make tea. 5 ml of this tea was dropped on to fabrics held at ˜70° inclined plane. The fabrics were then wiped with a tissue paper immediately and dried overnight.

### Coffee Stain Soiling

5 ml of instant coffee was dropped on to fabrics held at ˜70° inclined plane. The fabrics were then wiped with a tissue paper immediately and dried overnight.

### Wash Protocol

Typical wash protocol involved soaking 20 g of fabrics in 1 L of deionised water containing 3 g of Surf Excel (ex. Hindustan Unilever Limited) for 15 minutes. They were washed in a Tergotometer® (Instrument Marketing Services, USA) at 90 rpm for 30 minutes at ambient temperature. After washing, the fabrics were rinsed three times, each with 450 ml of water for 2 minutes in Tergotometer® at 90 rpm and dried in air. Wash protocol in hard water was same as the one described above in all respects except that instead of deionised water, 48 FH (Ca²⁺:Mg²⁺=2:1 molar ratio) water was used.

### Reflectance Measurement

Reflectance of all fabrics before and after washing were measured using Macbeth Reflectometer at wavelength 460 nm, UV excluded, SCI using a large aperture.

### Soil Repellency and Cleaning at 0 FH (Red Mud, Carbon Soot and Tea Stains)

Experiments were conducted with cotton, polycotton and polyester fabrics (having initial reflectance of 90) were treated as tabulated below. The treated fabrics were soiled and subsequently washed using wash protocol-1. The reflectance of the fabrics after soiling and after wash was measured and the values are tabulated below.

TABLE 6
Soil repellency and subsequent cleaning at 0 FH

| | | R460 (red mud) | | R460 (carbon soot) | | R460 (tea) | |
|---|---|---|---|---|---|---|---|
| Ex | | After | After | After | After | After | After |
| No | Fabric | soiling | Wash | soiling | Wash | soiling | Wash |
| 15 | Cotton | 76.6 ± 0.4 | 85.4 ± 0.3 | 62.2 ± 3.0 | 77.4 ± 0.6 | 69.7 ± 2.6 | 86.9 ± 0.3 |
| 16 | Cotton | 75.6 ± 0.6 | 84.7 ± 0.7 | 65.8 ± 3.7 | 79.1 ± 0.6 | 51.0 ± 3.3 | 87.4 ± 0.7 |
| 17 | Cotton | 75.0 ± 0.6 | 83.3 ± 1.8 | 59.6 ± 4.0 | 76.3 ± 0.6 | 72.7 ± 2.4 | 86.9 ± 0.3 |
| L | Cotton | 74.1 ± 0.2 | 82.9 ± 0.9 | 50.5 ± 2.9 | 63.6 ± 1.2 | 58.9 ± 1.3 | 84.9 ± 0.3 |
| 15 | Polycotton | 81.6 ± 0.7 | 84.2 ± 0.4 | 70.2 ± 6.2 | 81.5 ± 1.3 | 83.4 ± 1.5 | 85.6 ± 0.1 |
| 16 | Polycotton | 80.1 ± 1.4 | 83.3 ± 0.2 | 65.2 ± 3.7 | 79.1 ± 0.6 | 54.1 ± 0.6 | 85.2 ± 0.1 |
| 17 | Polycotton | 82.9 ± 0.2 | 85.4 ± 0.4 | 67.7 ± 1.9 | 81.3 ± 0.2 | 85.2 ± 0.1 | 85.6 ± 0.1 |
| L | Polycotton | 75.7 ± 0.3 | 81.9 ± 0.1 | 39.7 ± 3.9 | 63.6 ± 1.2 | 63.1 ± 5.1 | 83.9 ± 0.2 |
| 15 | Polyester | 85.8 ± 1.1 | 86.4 ± 0.5 | 79.5 ± 3.3 | 84.7 ± 0.5 | 84.8 ± 2.5 | 87.4 ± 0.4 |
| 16 | Polyester | 82.2 ± 1.8 | 86.5 ± 0.2 | 76.6 ± 1.3 | 84.0 ± 1.2 | 54.9 ± 0.5 | 87.3 ± 0.3 |
| 17 | Polyester | 86.2 ± 0.8 | 87.1 ± 0.6 | 81.1 ± 0.7 | 84.9 ± 0.1 | 84.4 ± 4.3 | 87.1 ± 0.2 |
| L | Polyester | 81.9 ± 1.8 | 86.5 ± 0.4 | 49.4 ± 3.1 | 71.3 ± 1.9 | 66.3 ± 0.9 | 86.8 ± 0.1 |

### Soil Repellency and Cleaning at 0 FH and 48 FH (Coffee Stain)

Experiments were conducted with cotton, polycotton and polyester fabrics (having initial reflectance of 90) were treated as tabulated below. The treated fabrics were soiled with the coffee soiling method, as described above. The soiled fabrics were washed using wash protocol. The reflectance of the fabrics after soiling and after wash was measured and the values are summarized below.

TABLE 7
Soil repellency and cleaning at 0 FH and 48 FH (Coffee stain)

| | | R460 (0 FH) | | R460 (48 FH) | |
|---|---|---|---|---|---|
| Ex | | After | After | After | After |
| No | Fabric | soiling | Wash | soiling | Wash |
| L | Cotton | 56.7 ± 0.9 | 85.6 ± 0.4 | 57.8 ± 1.3 | 85.6 ± 0.2 |
| 18 | Cotton | 83.5 ± 0.3 | 89.7 ± 0.1 | 84.7 ± 2.0 | 88.7 ± 0.2 |
| L | Polycotton | 56.1 ± 3.9 | 84.2 ± 0.3 | 54.0 ± 1.6 | 83.9 ± 0.1 |
| 18 | Polycotton | 80.5 ± 1.7 | 85.6 ± 0.3 | 81.9 ± 0.3 | 85.5 ± 0.3 |
| L | Polyester | 66.9 ± 3.0 | 84.7 ± 0.1 | 66.3 ± 1.4 | 84.3 ± 0.2 |
| 18 | Polyester | 76.4 ± 2.5 | 84.9 ± 0.2 | 70.2 ± 3.3 | 83.5 ± 0.3 |

Experiments were conducted with cotton, polycotton and polyester fabrics (having initial reflectance of 97) were treated with fabric treatment composition of Example 19 and with fabric treatment composition of Comparative Example L. The treated fabrics were soiled with the red mud soiling method. The soiled fabrics were washed using the wash protocol. The reflectance of the fabrics after soiling and after wash was measured and the values are summarized in Table 8.

TABLE 8
Soil repellency and subsequent cleaning
using alkaline water soluble compound

R460 (0 FH)

| Ex No | Fabric | After soiling | After Wash |
|---|---|---|---|
| L | Cotton | 60.8 ± 1.0 | 77.7 ± 0.9 |
| 19 | Cotton | 82.1 ± 0.7 | 92.8 ± 0.3 |
| L | Polycotton | 66.4 ± 0.7 | 82.7 ± 0.5 |
| 19 | Polycotton | 86.1 ± 2.3 | 93.0 ± 0.5 |
| L | Polyester | 77.5 ± 4.3 | 93.0 ± 0.7 |
| 19 | Polyester | 93.1 ± 1.7 | 96.8 ± 0.3 |

### Effect of pH Variation of Treatment on Red Mud Repellency

Experiments were conducted with cotton, polycotton and polyester fabrics (having initial reflectance of 97) were treated with fabric treatment composition of Example 15 at different pH as tabulated below. pH of 1.5 was attained by adding hydrochloric acid and pH of 9.5 was attained by adding sodium hydroxide. The treated fabrics were soiled with the red mud soiling method and tea soiling method, as described above. The soiled fabrics were washed using wash protocol described earlier. The reflectance of the fabrics after soiling and after wash was measured and the values are summarized in Table 9.

TABLE 9
Effect of pH variation of treatment on Red mud repellency

| | | R460 (pH = 1.5) | | R460 (pH = 4.5) | | R460 (pH = 9.5) | |
|---|---|---|---|---|---|---|---|
| | | After | After | After | After | After | After |
| Soil | Fabric | soiling | Wash | soiling | Wash | soiling | Wash |
| Red mud | Cotton | 56.7 ± 0.6 | 79.6 ± 0.9 | 78.2 ± 1.5 | 93.5 ± 0.6 | 69.2 ± 0.9 | 80.9 ± 1.0 |
| Red mud | Polycotton | 52.2 ± 0.2 | 76.5 ± 0.6 | 70.4 ± 4.2 | 81.7 ± 2.5 | 62.1 ± 0.1 | 73.6 ± 0.4 |
| Red mud | Polyester | 70.6 ± 0.9 | 91.7 ± 0.4 | 93.1 ± 0.9 | 97.9 ± 0.2 | 77.1 ± 0.8 | 92.5 ± 0.6 |
| Tea | Cotton | 58.8 ± 0.7 | 93.6 ± 0.4 | 81.1 ± 0.8 | 96.9 ± 0.2 | 61.5 ± 3.2 | 93.7 ± 0.7 |
| Tea | Polycotton | 48.7 ± 5.1 | 92.0 ± 0.2 | 62.7 ± 1.8 | 92.8 ± 0.3 | 46.3 ± 4.1 | 91.0 ± 0.5 |
| Tea | Polyester | 65.2 ± 0.6 | 96.2 ± 1.1 | 94.2 ± 1.7 | 98.4 ± 0.5 | 64.0 ± 0.9 | 95.3 ± 0.3 |

From the above results, it will be appreciated that the present invention provides a single-step method for imparting stain-resistance to a fabric whilst also improving subsequent cleaning efficacy.

### Fabric Treatment—Example 20

To 1 L of deionised water, 2.97 g of zinc nitrate, 1.8 g of aluminium nitrate nonahydrate, 0.8 g sodium hydroxide and 1 g of sodium laurate were added to obtain an aqueous component which had pH of 4.5.

40 fabrics each of 1 g (100 cm²) were soaked in 1 L of the above aqueous component for 60 minutes. After soaking the fabrics were rinsed once in 1 litre of deionised water and dried in air and ironed.

### Airborne Soiling Protocol

100 cm² cotton swatches were hung in exhaust of diesel engine operating at 4500 W for 3 hours.

### Repeated Airborne Soiling-Washing Cycles

The swatches, soiled according to the airborne soiling protocol were washed according to the protocol described earlier (at 0 FH). The cycle of airborne soiling and washing was repeated four times with the swatches treated after each wash with the fabric treatment composition of Example 20. Similar procedure was carried out with the fabric treatment composition of Comparative Example L. Reflectance was measured in each cycle after soiling and after washing and the results are tabulated below.

TABLE 10
Cleaning efficacy after repeated airborne soiling-washing cycles

| | Comparative Example L | | Example 20 | |
|---|---|---|---|---|
| | After soiling | After wash | After soiling | After wash |
| 1st cycle | 53.9 | 72.5 | 54.6 | 81.0 |
| 2nd cycle | 46.8 | 63.0 | 54.6 | 72.9 |
| 3rd cycle | 42.3 | 59.2 | 48.1 | 68.8 |
| 4th cycle | 39.1 | 56.0 | 42.5 | 64.7 |

From the results, it is clear that the fabric treatment according to the present invention provides better cleaning efficacy after repeated airborne soiling-washing cycles.

### Hard Surface Treatment—Glass Surface

### Formulation

A stable liquid suspension composed of 1 g/L PACI (Poly Aluminium Chloride, ex Grasim, India)+0.5 g/L DCFA (Na-salt of distilled coco-fatty acid ex Godrej Industries Ltd, India) was used in one case. Glass slides were soaked in it for 10 minutes, removed and then air dried. After drying the surface was wiped to ensure complete drying—This treatment rendered it hydrophobic.

### Application

The formulation was be sprayed over the glass surface. The layer of liquid was left on the glass surface for 5-10 min for the layer to deposit.

After complete drying the glass surface was found to be hydrophobic, by water droplet contact angle testing.

The contact time between the liquid formulation and the glass surface can be reduced from 5-10 minutes to almost less than a minute by increasing the concentration.

In another example, another stable liquid suspension composed of 10 g/L PACI+5 g/L DCFA (Na-salt of distilled coco-fattyacid) was made and it was sprayed onto the glass surface, it was kept for about 30 secs and then wiped dry with a tissue paper. Care was taken to see that the surface was completely dry and transparent.

The glass surface was found to be hydrophobic, by water droplet contact angle testing.

### Oily Soil Repellence

100 g of Cotton fabrics were soaked in 1 liter of water containing the following treatments (21 and 22 and comparative examples M to P) for 30 minutes. The fabrics were rinsed in water and dried in air and soiled and cleaned using protocols given below.

| Treatment | Rinse |
|---|---|
| 21 | 0.5 g/l Poly aluminium chloride + 0.5 g/l Potassium myristate |
| 22 | 0.5 g/l Poly aluminium chloride + 0.5 g/l Potassium |
| | myristate + 0.2 g/l PDMS emulsion (30% active) |
| M | 0.2 g/l PDMS emulsion (30% active) |
| N | 1 g/l PDMS emulsion (30% active) |
| O | 5 g/l PDMS emulsion (30% active) |
| P | Water |

The PDMS, a quaternary silicone, as used in the example is in the form of an emulsion in water containing 35% active, 5% D5 (Cyclopentasilioxane), 5% cationic surfactant, 5% Non-ionic) and water.

### Soiling Protocol

### 1 Carbon Soiling

The 100 cm² swatches of the above treated fabrics were placed on a white board. To each swatch, 5 ml of 20 ppm Carbon soot dispersion dispersed in 3 ppm NaLAS was added. The liquid was rolled with a glass rod four times and the fabrics were dried in air. Extent of soiling of the fabrics were measured using reflectance and through image analysis.

### 2 Oil Soiling

Coconut oil (commercial available brand: Parachute) was colored using trace amount of Orange OT dye. The treated fabrics (21, 22, M-P) were cut in to 5 cm×1 cm strips and held vertically using a clamp. 0.1 ml of the colored coconut oil was added to each of the cotton fabrics and the spreading area was measured after 10 seconds. Three fabrics of each treatment under went the same soiling procedure and average spreading area for each treatment was obtained.

### Washing Protocol

100 g of Carbon soot soiled fabrics were soaked in 1 litre of deionized water containing 3 g of Surf Excel Quickwash powder (ex. Hindustan Unilever Limited) for 30 minutes. The soaked fabrics were washed by hand wash in a regimental fashion with 10 brushing (5 brushing on each side) and rinsed in water for three times. The fabrics were then dried in air and the reflectance was measured as before.

### Reflectance Measurement

Reflectance of all fabrics before and after washing were measured using Macbeth Reflectometer at wavelength 460 nm, UV excluded, SCI using a large aperture (LAV).

### Image Analysis

The soiled and washed fabrics after drying were scanned using HP Scanner in 256-bit colour scale. The images were captured in jpg format and analysed using ImageJ software using histogram analysis mode. A value of 0 refers to complete black while a value of 255 refers to complete white.

### Carbon Soiling and Detergency

Aqueous Carbon soot was used as model aqueous soil and treated fabrics were soiled and washed as described above. Larger the spreading lesser is the repellency

| | R 460* | R 460* | Image J data | Image J data |
|---|---|---|---|---|
| Treatment | Before Wash | After wash | before wash | after wash |
| 21 | 74.5 | 78.0 | 239.51 | 246.30 |
| 22 | 77.0 | 79.9 | 238.71 | 247.11 |
| M | 57.9 | 59.5 | 219.06 | 226.43 |
| N | 52.3 | 59.8 | 203.54 | 220.20 |
| O | 55.4 | 57.8 | 207.95 | 221.56 |
| P | 50.8 | 61.2 | 206.26 | 222.48 |

The above data shows that both in terms of reflectance as well as in terms of Image analysis, fabrics treated with treatments 21 and 22 are superior to all other treatments before and after wash clearly showing that treatments 21 & 22 provide aqueous soil repellency as well as cleaning

### Oil Soiling

Coloured Coconut oil was used as a model oily soil and its spreading on various treated fabrics have been taken as repellency of oily soil.

| Formulation | Average Spreading Area (cm²) |
|---|---|
| 21 | 1.7 ± 0.2 |
| 22 | 1.0 ± 0.1 |
| M | 1.4 ± 0.1 |
| N | 1.3 ± 0.1 |
| O | 0.9 ± 0.1 |
| P | 1.8 ± 0.1 |

From the oil spreading area, it is clear that treatments 22 and O show less oil spreading compared to the other examples. A treatment of PDMS alone (Treatment E) could provide oily soil repellency, but only at a very high level of PDMS (25 times more as compared to 22)

Thus treatment 21 provides aqueous soil repellency and cleaning while treatment 22 further provides oily soil repellency in addition to aqueous soil repellency and cleaning.

1. A method of treatment of a substrate comprising the step of contacting the substrate with an aqueous component comprising water and a composition comprising:
(a) 0.001 to 0.5% of a soap by weight of the aqueous component, and
(b) 0.001 to 0.5% of polyaluminum chloride by weight of the aqueous component,
wherein pH of the aqueous component is less than 6.

2. A method as claimed in claim 1, wherein the composition further comprises a quaternary silicone oil.

3. A method as claimed in claim 1 wherein said composition comprises a pH modifying agent in order to maintain said pH below 6.

4. A solid composition for treatment of a substrate comprising:
(a) from 30 to 90% a soap,
(b) from 30 to 90% of polyaluminum chloride, and;
(c) from 0 to 20% of a pH modifying agent,
wherein pH of 1% by weight of the composition in water is less than 6.

5. A composition as claimed in claim 4, wherein the composition further comprises a quaternary silicone oil.

6. Use of a composition according to claim 4 for rendering a substrate hydrophobic.

7. Use of a composition according to claim 4 for rendering a substrate stain repellent.
